(19) United States
(12) Patent Application Publication
(10) Pub. No.: US 2006/0090711 A1
(43) Pub. Date: May 4, 2006

(54) Animal coat harness

(76) Inventor: Ruth E. Richards, Lake Orion, MI (US)

Correspondence Address: HARNESS, DICKEY & PIERCE, P.L.C., P.O. BOX 828, BLOOMFIELD HILLS, MI, 48303, US

(21) Appl. No.: 11/214,181

(22) Filed: Aug. 29, 2005

Related U.S. Application Data
(60) Provisional application No. 60/624,088, filed on Nov. 1, 2004.

(51) Int. Cl. A01K 13/00

(52) U.S. Cl. 119/850

(57) ABSTRACT

An animal harness coat includes a cover and a harness. The cover and harness are attached together. The cover allows the leash to be attached to the harness. The harness includes a front strap that extends entirely around the neck portion of the animal and a second strap that extends entirely around the body of the animal between the front legs and the hind quarters. As such, a force imparted on the harness through a leash is safely transmitted to the collarbone region and ribcage area of the animal.

### CROSS-REFERENCE TO RELATED APPLICATIONS

This application claims the benefit of U.S. Provisional Application No. 60/624,088 filed on Nov. 1, 2004. The disclosure of the above application is incorporated herein by reference.

### FIELD OF THE INVENTION

The present invention relates to protective gear for animals and, more particularly, to an animal coat that can be releasably secured to an animal.

### BACKGROUND OF THE INVENTION

Protective gear for animals, such as dogs, cats, sheep, horses, etc., are used to protect against weather (i.e., snow, rain, cold; etc.) and/or to add visibility so as to protect the animals against hunters, moving vehicles and the like. There are many types of protective coats or covers on the market designed to protect against the weather and/or to add visibility. The coats, however, may lack the ability to safely and securely attach a leash or restraint to the animal wearing the coat. Typically, harnesses are used to safely and securely attach an animal to a leash or lead. The harness transmits force from the leash to the collarbone/chest area of the animal and to the ribcage area of the body of the animal between the front legs and hind quarters. The transmitting of the force to these areas of the animal reduces discomfort associated with the forces transmitted from a leash to the animal. The coats that are currently available, however, inhibit the use of a harness in conjunction with the coat. Accordingly, the benefits of a harness may not be achieved in conjunction with the benefits of a coat. Thus, it would be advantageous to combine the benefits of a harness with that of a coat into a single component providing both of these features and benefits.

Furthermore, it would be advantageous if the coat were made from multiple layers of differing materials. This allows the coat to provide specific features or functionality, such as waterproof or resistance, water retention, insulation, increased visibility and the like, for each individual layer. It would be further advantageous if such a multi-layer coat included a feature allowing a leash to be attached thereto. Moreover, it would be advantageous if a coat for an animal had additional features and functionality that enhanced the versatility of the coat. For example, it would be advantageous for the coat to have one or more accessible pockets allowing objects, such as keys, money, phones and the like to be stored therein. Additionally, it would be advantageous if the coat could have one or more pockets which could receive buoyant materials so that the coat may also facilitate the swimming of the animal in water. Additionally, it would be advantageous if the coat contained a handle that facilitated the lifting of the animal while wearing the coat.

### SUMMARY OF THE INVENTION

An animal coat according to the principles of the present invention advantageously reduces or avoids one or more of the drawbacks discussed above. Additionally, the coat advantageously provides additional functionality and features heretofore not available. The coat is designed for use on an animal having a head, a neck, a chest, a body, front legs and hind quarters.

In one aspect of the present invention such an advantageous animal apparatus is disclosed and includes a coat portion and a harness portion. The coat portion is positionable on the animal and covers a portion of the body between the front legs and the hind quarters with a bottom side facing the body. The harness portion is secured to the coat portion. A first strap of the harness portion is secured to the coat portion and is releasably positionable to extend entirely around the neck. The first strap is operable to transmit a force to a collarbone region of the chest of the animal. A second strap of the harness portion is secured to the coat portion and is releasably positionable to extend entirely around the body between the legs and the hind quarters. The second strap is operable to transmit a force to a ribcage area of the body of the animal. A connection member is connected to at least one of the first and second straps and is accessible from the top side of the coat portion. The connection member allows the attachment of a leash to the harness portion.

In another aspect of the present invention, an animal coat is disclosed. The animal coat includes a cover having first and second layers attached together. The cover is positionable on the animal and covers a portion of the body between the front legs and the hind quarters with the first layer contacting the body. The first and second layers are different materials. A harness is attached to the cover. A first releasably securable portion of the harness extends entirely around the neck of the animal while a second releasably securable portion of the harness extends entirely around the body of the animal between the front legs and the hind quarters. The harness is configured to allow a leash to be connected thereto and transmits a force applied by the leash to a collarbone region of the chest and to a ribcage area of the body through the first and second portions respectively.

In yet another aspect of the present invention, an animal coat including a cover with opposite top and bottom sides is disclosed. The cover is releasably positionable on the animal and covers a portion of the body between the front legs and the hind quarters with the bottom side facing the body. The coat includes at least one accessible pocket operable to hold an object therein.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1 and 2 are respective top and bottom plan views of a harness coat according to the principles of the present invention;

FIG. 3 is a cross-sectional view along line 3-3 of the harness coat of FIG. 1;

FIG. 4 is a perspective view of an animal wearing the harness coat of FIG. 1;

FIG. 5 is a perspective view of an animal wearing a first alternate embodiment of a harness coat according to the principles of the present invention;

FIG. 6A is a cross-sectional view of a portion of the harness coat along line 6-6 of FIG. 5 showing a pocket on the harness coat;

FIG. 6B is a cross-sectional view of a portion of the harness coat along line 6-6 of FIG. 5 showing a pocket on the harness coat with a buoyant member disposed therein; and

FIG. 7 is a perspective view of a second alternate embodiment on the harness coat according to the principles of the present invention on an animal.

### DETAILED DESCRIPTION OF THE PREFERRED EMBODIMENTS

The following description of the preferred embodiment(s) is merely exemplary in nature and is in no way intended to limit the invention, its application, or uses.

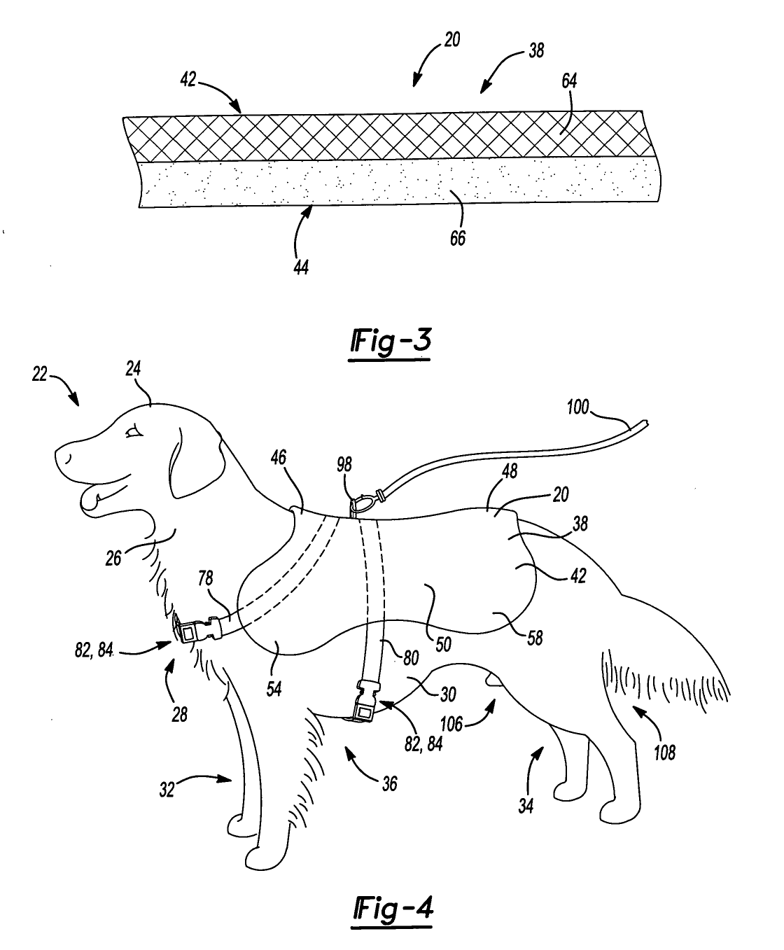

A harness coat 20 according to the preferred embodiment of the present invention is shown in FIGS. 1-4. Harness coat 20 is designed to be utilized on an animal 22 having a head 24, neck 26, a chest or collarbone area 28, a body 30, front legs 32, hind quarters 34 and a ribcage area 36 along body 30 between front legs 32 and hind quarters 34. As such, harness coat 20 can be used on a variety of different animals. For example, such animals include, but are not limited to, dogs, cats, sheep, horses and the like. Harness coat 20 can be utilized to provide protection for animal 22, such as protection against the weather (i.e., snow, rain, cold, etc.) and/or to add additional visibility so as to protect animal 22 from hunters, traffic and the like. Harness coat 20 is designed to cover a portion of body 30 from the back of neck 26 to hind quarter 34. It should be appreciated, however, that harness coat 20 can be configured to provide additional or lesser coverage for animal 22.

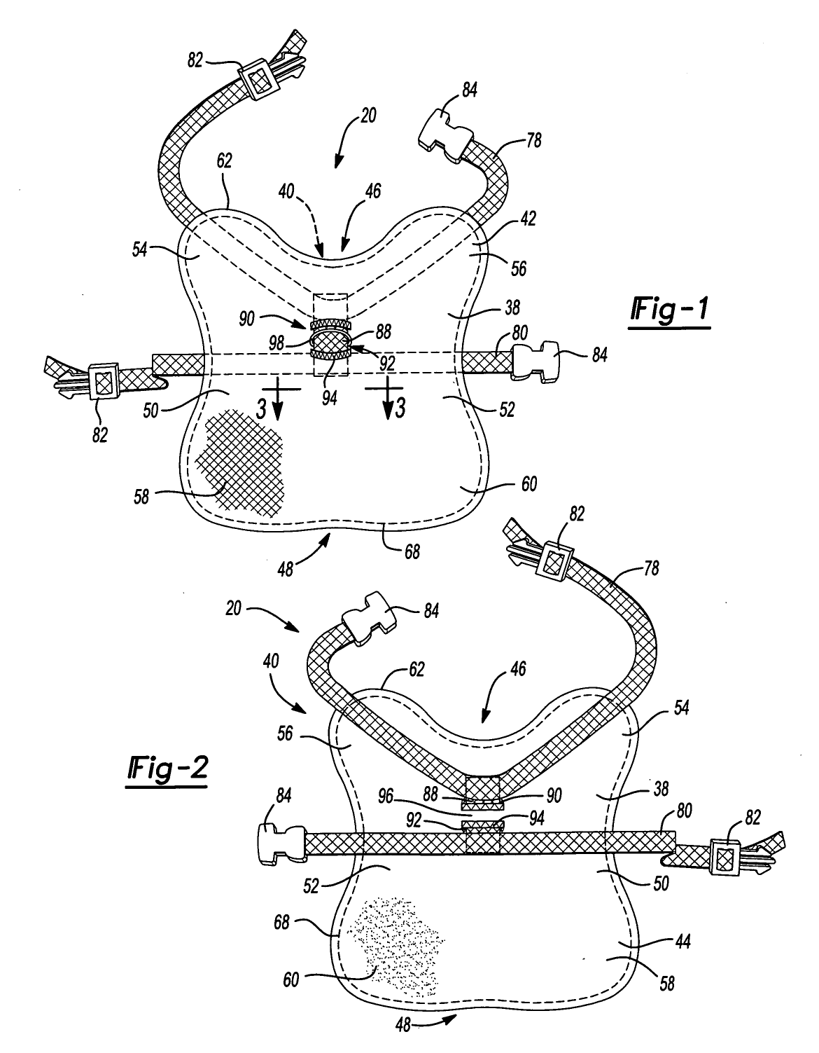

Referring now to FIGS. 1 and 2, harness coat 20 includes a cover 38 attached to a harness 40. Cover 38 has opposite top and bottom sides 42, 44. Bottom side 44 faces body 30 of animal 22 when positioned thereon. Cover 38 includes a front portion 46 and a rear portion 48. Front portion 46 is adjacent neck 26 while rear portion 48 is adjacent hind quarters 34 when positioned on animal 22. A left side portion 50 rests on the left side of body 30 while a right side portion 52 rests on the right side of body 30. Left and right side portions 50, 52 include respective left and right shoulder portions 54, 56 that cover the respective left and right shoulder portions of front legs 32 of animal 22. Left and right side portions 50, 52 also include respective left and right hind quarter portions 58, 60 that rest on the respective left and right hind quarters 34 of animal 22. A side edge 62 defines the periphery of cover 38.

Cover 38 is preferably made from two different layers of material 64, 66. First material 66 forms top side 42 while second material 66 forms bottom side 44. First and second materials 64, 66 are preferably made of different materials. By using different materials, cover 38 can provide differing functionalities for the different sides. For example, first material 64 can be a water-resistant or waterproof material while second material 66 can be an insulating material. Various materials can be used to form first and second material layers 64, 66. For example, such materials include but are not limited to cotton, cotton canvas, fleece, wool, faux sheepskin, nylon, polyester and blends thereof and the like. Additionally, the materials can be water repellant or waterproof and/or can have a water repellant added thereto. First material 64 may be patterned to provide a desired appearance. Moreover, first material 64 may be reflective or have high visibility characteristics to increase the visibility of an animal 22 wearing harness coat 20.

First and second material 64, 66 are attached together via stitching 68 that extends along cover 38 adjacent side edge 62. Additional stitching (not shown) can be used throughout cover 38 to secure first and second material 64, 66 together. Additionally, stitching (not shown) can be used to emboss cover 38 with a desired pattern or image. Preferably, the stitching used throughout harness coat 20 is high strength and weather resistant, such as a heavy-duty industrial grade thread.

Harness 40 includes a front or neck strap 78 and a rear or body strap 80. Front strap 78 is attached to bottom side 44 of cover 38 by stitching (not shown) such that front strap 78 extends from a central portion of cover 38 through left and right shoulder portions 54, 56. Rear strap 80 is attached to bottom side 44 of cover 38 with stitching (not shown) such that rear strap 80 extends from a central portion of cover 38 laterally through left and right side portions 50, 52 between the shoulder and hind quarter portions. Preferably, front and rear straps 78, 80 are each formed from a continuous single piece of the strap material. It should be appreciated, however, that each strap 78, 80 can be formed from a plurality of discreet individual strap members attached together, such as by stitching, to form the entire front and rear straps 78, 80. Straps 78, 80 can be made from a variety of materials. Such materials include, but are not limited to, polypropylene, nylon, rope and the like. Straps 78, 80 are sized and the materials chosen to be appropriate for the intended size of animal 22 upon which harness coat 20 is to be utilized. By having each strap 78, 80 forming a loop that encircles the appropriate portions of animal 22, straps 78, 80 advantageously avoid stress on cover 38 that may cause cover 38 to tear, stretch or be damaged. Additionally, the forming of the entire loop with straps 78, 80 also ensures that the forces applied by harness 40 are directed to and dispersed across the appropriate areas of animal 22 in a safe manner. Preferably, the entire portion of front and rear straps 78, 80 that extend along bottom side 44 of cover 38 are attached thereto. As such, a complete and secure attachment between straps 78, 80 and cover 38 is achieved. Additionally, the continuous nature of the attachment between straps 78, 80 and cover 38 eliminates and/or minimizes any pull on cover 38 as a result of a leash attached thereto.

Complementary male and female fastening members 82, 84 are disposed on the ends of front and rear straps 78, 80. Fastening members 82, 84 allow front strap 78 to be releasably secured around neck 26 of animal 22 and rear strap 80 to be releasably secured around body 30 of animal 22 between front legs 32 and hind quarters 34. Preferably, one or more fastening member 82, 84 allows the effective length of straps 78, 80 to be changed to accommodate the differing sizes of animals upon which harness coat 20 may be used. Fastening members 82, 84 may be made from a variety of materials. Such materials include, but are not limited to, metal, polymers and the like. Fastening members 82, 84 are sized to be appropriate for the intended size of animal 22.

A connecting member 88 extends between front and rear straps 78, 80. Preferably, connecting member 88 is also a strap that is connected to both front strap 78 and rear strap 80 by stitching (not shown). Strap 88 is preferably made of the same material as straps 78, 80. Strap 88 is woven between two reinforced openings 90, 92 and a rib 96 of cover 38 extending therebetween. Openings 90, 92 are similar to buttonholes and have stitching 94 along their edges to reinforce cover 38 and prevent tearing or damage to cover 38. Strap 88 may also be attached to bottom side 44 of cover 38 via stitching (not shown).

A rigid ring-like member, such as a D-ring 98, extends around strap 88 and extends outwardly from top side 42 of cover 38. Ring 98 allows a leash, lead or the like 100 to be releasably attached to harness coat 20. Having ring 98 extending from top side 42 of cover 38 facilitates the attachment of leash 100 thereto. Ring 98 can be made, by way of non-limiting example, of polymer or metal and is chosen to be of appropriate size for the intended animal.

To attach harness coat 20 to animal 22, harness coat 20 is positioned along the back of body 30. Front strap 78 is positioned around neck 26 and releasably fastened together with fastening members 82, 84. The length of front strap 78 can be adjusted, as needed, to provide the desired fit around animal 22. Front strap 78 is adjusted so that a force imparted by front strap 78 onto animal 22 occurs in the chest/collarbone area 28. Rear strap 80 is positioned around body 30 between front legs 32 and hind quarters 34 and releasably fastened together with fastening members 82, 84. The length of rear strap 80 can be adjusted, as needed, to achieve a desired fit on animal 22. Rear strap 80 is adjusted so that a force imparted by rear strap 80 on animal 22 is distributed over ribcage area 36. With harness coat 20 properly secured on animal 22, a force exerted on harness coat 20 by leash 100 is transmitted via ring 98 and interconnecting strap 88 to front and rear straps 78, 80. Front and rear straps 78, 80 consequently exert the force along chest/collarbone area 28 and ribcage area 36 thus providing a safe application of restraining force to animal 22. That is, this configuration advantageously reduces the potential for injury to the neck 26 or ribs of animal 22. Additionally, with this configuration, it may be possible for a care giver to lift smaller animals straight up without harm to the animal, simulating the lifting on the nape of the neck by the mother of the animal.

When it is desired to remove harness coat 20 from animal 22, fastening members 82, 84 on front and rear straps 78, 80 are disengaged. Harness coat 20 can then be removed from animal 22. As can be seen, the configuration of harness coat 20 does not interfere with the penis area 106 or anal area 108 of animal 22. As such, harness coat 20 does not interfere with the excretory functions of animal 22 and is not soiled when animal 22 urinates or has a bowel movement.

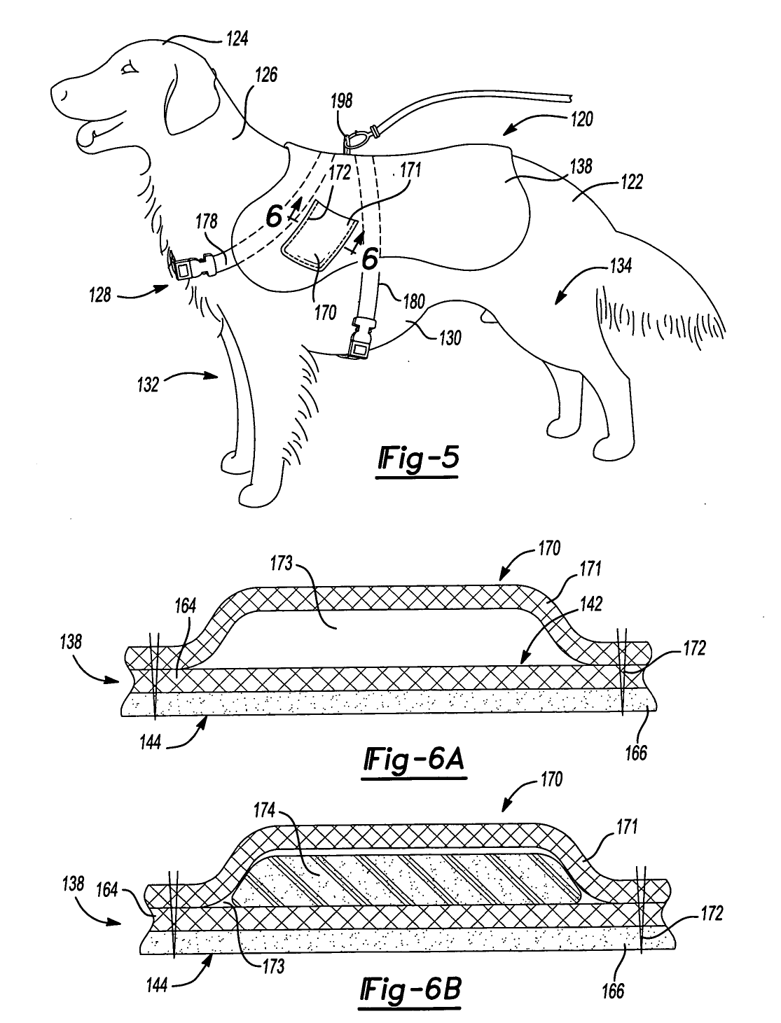

Referring now to FIGS. 5 and 6, a harness coat 120 according to a first alternate embodiment is shown. Harness coat 120 is substantially the same as harness coat 20 described above in reference to the preferred embodiment with the addition of a pocket 170 on top side 142. Pocket 170, as shown in FIG. 6A, includes an additional layer of material 171 attached to top side 142. Preferably, layer 171 is made of the same material as first material 164. Layer 171 is attached to cover 138 with stitching 172. A cavity 173 is formed between layer 171 and first material 164. Cavity 173 enables objects to be stowed therein. For example, keys, money, phone, wallet, etc. can be placed in cavity 173. Pocket 170 thereby advantageously provides a storage area for possessions of the caretaker when animal 122 is wearing harness coat 120. Such can be useful when taking animal 122 for a walk and maintaining the objects on the person of the caretaker is impractical. A closure mechanism (not shown), such as a snap, button, Velcro® and the like may be utilized in conjunction with pocket 170 to limit the access to cavity 173. Furthermore, if desired, a flap may be disposed over the entryway to cavity 173 to also limit the accessibility to cavity 173. Pocket 170 can be a single pocket or it can be multiple pockets disposed along various portions of top side 142 of cover 138. Additionally, pocket 170 can be of a variety of sizes or be disposed in a variety of locations along top side 142 of cover 138. For example, pocket 170 can be disposed in hind quarter portion(s) 58, 60, if desired.

In one embodiment, as shown in FIG. 6B, a removable buoyant member 174 can be disposed within cavity 173 of pocket 170. In this case, buoyant member 174 enables harness coat 120 to facilitate floatation of animal 122. Buoyant member 174 can be made from a variety of buoyant materials. By way of non-limiting example, buoyant member 174 can be made from a closed-cell foam. When harness coat 120 includes removable buoyant members 174, it is preferred that there be a pocket 170 on both the left and right portions of cover 138. Additionally, it should be understood that the exact position and shape of pocket 170 when designed to receive a removable buoyant member 174 will be positioned and sized to provide the floatation assistance for the size of animal 122 expected to be utilized with the particular harness coat 120.

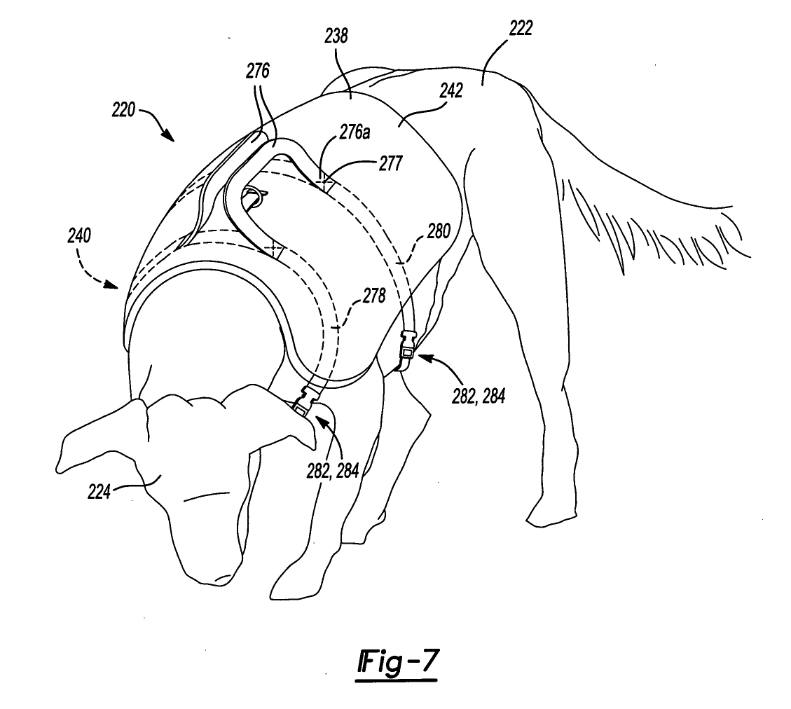

Referring now to FIG. 7, a harness coat 220 according to a second alternate embodiment is shown. Harness coat 220 is essentially the same as harness coat 20 discussed above with reference to the preferred embodiment with the addition of handles 276. Handles 276 are secured to harness 240 through cover 238 by stitching 277. Ends 276a of handles 276 are attached to front and rear straps 278, 280 with stitching 277 that extends through cover 238. Handles 276 may advantageously allow animal 222 to be lifted. With handles 276 secured to front and rear straps 278, 280, safe lifting of animal 222 is facilitated and simulates the lifting from the nape of the neck by the animal's mother. It should be appreciated, however, that handles 276 can be advantageously used in conjunction with the pockets and buoyant members disclosed in reference to the first alternate embodiment to facilitate the lifting of animal 222 from the water.

The description of the invention is merely exemplary in nature and variations that do not depart from the gist of the invention are intended to be within the scope of the invention. For example, while the cover portion of the harness coat is described as using two different materials, it should be appreciated that the two layers can be of the same material if desired. Additionally, it should be appreciated that the cover portion can consist of a single layer of material or more than two layers of material. It should further be appreciated that the straps can be attached to the cover with something other than stitching. For example, rivets, zippers, and weaving of the straps through a multitude of reinforced buttonholes and the like may be used. Moreover, while the harness is shown as being secured to the bottom side of the cover, the harness can extend over the exterior or top side of the cover. Additionally, while the harness is shown and described as being fixedly attached to the cover, it should be appreciated that the cover may be removable from the harness. For example, the cover can be secured to the harness via the use of Velcro®, buttons, snaps and the like to allow use of the harness separate from the cover. Furthermore, it should be appreciated that while relative dimensions of the harness coat to the animal are shown, the size and shape and relative dimensions may vary from that shown as desired. Thus, it should be appreciated that such variations are not to be regarded as a departure from the spirit and scope of the invention.

What is claimed is:

1. An animal apparatus for use on an animal having a head, a neck, a chest, a body, front legs and hind quarters, the animal apparatus comprising:
a coat portion having opposite top and bottom sides, said coat portion positionable on the animal and covering a portion of the body between the front legs and the hind quarters with the bottom side facing the body; and
a harness portion secured to said coat portion, said harness portion including:
(a) a first strap secured to said coat portion and releasably positionable to extend entirely around the neck, said first strap operable to transmit a force to a collarbone region of the chest of the animal;
(b) a second strap secured to said coat portion and releasably positionable to extend entirely around the body between the front legs and the hind quarters, said second strap operable to transmit a force to a rib cage area of the body of the animal;
(c) a connection member connected to at least one of said first and second straps and accessible from said top side of said coat portion, said connection member operatively allowing attachment of a leash to said harness portion.

2. The animal apparatus of claim 1, wherein said connection member is a third strap that interconnects said first and second straps to thereby transmit a force applied to said third strap to both of said first and second straps.

3. The animal apparatus of claim 2, wherein at least a portion of said third strap extends along said top side of said coat portion.

4. The animal apparatus of claim 2, further comprising a rigid ring like member attached to said third strap and operatively allowing attachment of a leash to said harness portion.

5. The animal apparatus of claim 1, wherein an entire portion of said first strap that is adjacent said coat portion is secured thereto and an entire portion of said second strap that is adjacent said coat portion is secured thereto.

6. The animal apparatus of claim 1, wherein said first and second straps extend along and are secured to said bottom side of said coat portion.

7. The animal apparatus of claim 1, wherein at least one of said first strap and said second strap is a single continuous strap having complementary connecting members on each end thereby allowing the at least one of said first strap and said second strap to be releasably secured around the animal.

8. The animal apparatus of claim 1, wherein at least one of said first and second straps is comprised of a plurality of discrete strap members secured together.

9. The animal apparatus of claim 1, wherein said coat portion includes an accessible pocket.

10. The animal apparatus of claim 1, further comprising at least one handle secured to said harness portion and extending outward from said top side of said coat portion, said handle operatively facilitating lifting of the animal.

11. An animal coat for use on an animal having a head, a neck, a chest, a body, front legs and hind quarters, the coat comprising:
a cover having first and second layers attached together, said cover positionable on the animal and covering a portion of the body between the front legs and the hind quarters with the first layer contacting the body, said first and second layers being different materials; and
a harness attached to said cover, a first releasably securable portion of said harness extending entirely around the neck of the animal and a second releasably securable portion of said harness extending entirely around the body of the animal between the front legs and the hind quarters, said harness configured to allow a leash to be connected thereto and transmit a force applied by a connected leash to a collarbone region of the chest and a rib cage area of the body of the animal through both of said first and second portions respectively.

12. The animal coat of claim 11, wherein a third portion of said harness interconnects said first and second portions and is configured to allow a leash to be connected thereto.

13. The animal coat of claim 12, wherein said first, second and third portions of said harness are straps.

14. The animal coat of claim 11, wherein said first layer is cotton.

15. The animal coat of claim 11, wherein said second layer is a water resistant layer.

16. The animal coat of claim 11, wherein said cover includes a pocket attached to said second layer.

17. A coat for an animal having a head, a neck, a chest, a body, front legs and hind quarters, the coat comprising:
a cover having opposite top and bottom sides, said cover releasably positionable on the animal and covering a portion of the body between the front legs and the hind quarters with the bottom side facing the body; and
at least one accessible pocket operable to hold an object therein.

18. The coat of claim 17, wherein the cover includes at least two connectors operable to secure a first portion of the cover around the neck and a second portion of the cover around the body between the front legs and the hind quarters and an attachment member to which a leash may be connected.

19. The coat of claim 18, further comprising a harness attached to said coat, a first portion of said harness releasably positionable to extend entirely around the neck and transmit a force to a collarbone region of the chest of the animal, a second portion of said harness releasably positionable to extend entirely around the body between the front legs and the hind quarters and transmit a force to a rib cage area of the body of the animal and a third portion of said harness operable to be attached to a leash and transmit a force from an attached leash to said first and second portions of said harness.

20. The coat of claim 17, further comprising a closure member operable to limit access to an interior of said pocket.

21. The coat of claim 17, wherein said pocket is on said top side of said cover.

22. The coat of claim 17, further comprising a removable buoyant member disposed within said pocket and facilitating floatation of an animal secured to said cover.

23. The coat of claim 17, further comprising a handle extending from said top side of said cover, said handle facilitating lifting of an animal secured to said cover.
